(19) United States
(12) Patent Application Publication
(10) Pub. No.: US 2024/0053293 A1
(43) Pub. Date: Feb. 15, 2024

(54) DEVICE FOR ANALYSING A BIOLOGICAL FLUID

(71) Applicants: Yuli CAMARGO NUNEZ, ROME (IT); Camillo Francesco Angelo PAPA, Castelnovo Bariano (RO) (IT); S2G TECHNOLOGIES S.R.L. STARTUP COSTITUITA Al SENSI DELL'ART. 4, COMMA10-BIS D.L. 3/2015 CONVERTITO, ROME (IT)

(72) Inventors: Emanuela SIGNORI, Rome (IT); Giorgio CONTINI, Rome (IT); Laura MICHELI, Rome (IT); Andrea Maria DI LELLIS, Rome (IT); Yannick Maria TEDESCHI, Rome (IT); Rocco CANCELLIERE, Longano (IS) (IT)

(21) Appl. No.: 18/258,141

(22) PCT Filed: Dec. 15, 2021
(86) PCT No.: PCT/IB2021/061752

§ 371 Date: Jun. 16, 2023

(30) Foreign Application Priority Data
Dec. 17, 2020 (IT) 102020000031163

(51) Int. Cl. G01N 27/327; G01N 27/417; G01N 27/413

(52) U.S. Cl. CPC G01N 27/3277; G01N 27/417; G01N 27/413

(57) ABSTRACT

Described is a basic device for analysing a biological fluid comprising at least one pair of electrodes (2) and a source of electricity (3) acting in conjunction to form an electrochemical cell to which the biological fluid is conveyed by means of a micro-fluid circuit (5). A functionalized coating is applied to the pair of electrodes (2) for receiving and retaining at least one marker of the biological fluid. The device also comprises a sensor (4) configured to measure a current signal in the electrochemical cell and a transmission module (6) with which it can be transmitted. Several basic measuring devices can be combined together to make a more complex system for use, for example, in hospitals or for testing laboratories which is able to perform many measurements in parallel providing multiple responses in the shortest possible time.

This invention relates to the technical sector of devices for medical use.

More specifically, the invention relates to a portable device for analysing a biological fluid in order to identify the presence and concentration of one or more markers inside the biological fluid.

The analysis can concentrate specifically on the detection of markers in the serum/blood of a user suitable for identifying inflammatory and/or hypercoagulation states. The portable device may also have variants which replicate the measurement principle on a larger scale for making more complex machines which are able to process several analyses simultaneously in order to accelerate the response times for structures such as, for example, testing laboratories or hospital structures which must process a large number of samples.

Their detection is particularly useful for the diagnosis, monitoring and prognosis of many pathologies such as: viral, bacterial, autoimmune, diabetic pathologies, cardiovascular diseases, ophthalmic diseases as well as autoimmune diseases such as lupus or rheumatoid arthritis, or infectious diseases, such as sepsis.

Currently, the method commonly used for measuring markers in the bodily fluids, serum and blood in particular, lies in the enzyme-linked immunosorbent assay (ELISA) or immunochromatographic assay (same principle as a pregnancy test).

Even though these techniques are effectively able to detect in an optimum manner and with high levels of sensitivity the presence of the markers of interest, it is also true that in order to be performed correctly they require trained personnel, laboratories with automated apparatuses, expensive reagents.

Moreover, the prior art techniques take a lengthy time to obtain results, since they involve the collection of biological samples, their transfer to a laboratory, analysis of the samples and processing of the data obtained from an optical reading.

These features make the prior art tests relatively complex, expensive and without immediate results.

The need is therefore strongly felt in the trade to develop new devices and methods which are able to provide clear and precise results in a short time.

In recent years, therefore, many research activities have been focussed on the development of electrochemical systems for a rapid determination of the presence in a biological fluid of markers which can be associated with different pathologies.

The advantage would lie in the high sensitivity of the electrochemical detection and the possibility of working with small volumes and with samples which are simply diluted and not purified.

Up to now, despite the results obtained, all the works published use the traditional electrochemical cells consisting of traditional electrodes using bench instruments which still require the transfer of the biological fluid to a laboratory for its analysis with the consequent need to involve expert and skilled personnel in order to obtain the information of interest.

In this context, the technical purpose which forms the basis of this invention is to provide a portable device for analysing a biological fluid which overcomes at least some of the above-mentioned drawbacks of the prior art.

More specifically, the aim of the invention is to provide a portable device for analysing a biological fluid which is able to quickly and precisely analyse a biological fluid to identify the presence and the concentration of specific markers.

The technical purpose indicated and the aims specified are substantially achieved by a portable device for analysing a biological fluid comprising the technical features described in one or more of the appended claims.

The invention describes a device for analysing a biological fluid which comprises at least one pair of electrodes, a source of electricity, a sensor, a micro-fluid circuit and a transmission module.

The at least one pair of electrodes comprises a functionalized coating for receiving and retaining at least one marker of the biological fluid.

The source of electricity is connected with the at least one pair of electrodes in such a way as to define with it an electrochemical cell.

The sensor is configured to measure a current signal flowing in the electrochemical cell.

More specifically, an amplitude of the current signal is inversely proportional to a quantity of markers retained by the coating.

The micro-fluid circuit is configured for conveying the biological fluid on the coating.

The transmission module is configured for transmitting the current signal.

Advantageously, the device described here makes it possible to collect information in a fast and efficient manner which may be directly associated with the concentration of the marker in the biological fluid.

The dependent claims, incorporated herein for reference, relate to different embodiments of the invention.

Further features and advantages of this invention are more apparent in the detailed description below, with reference to a preferred, non-restricting, embodiment of a portable device for analysing a biological fluid as illustrated in the accompanying drawings, in which:

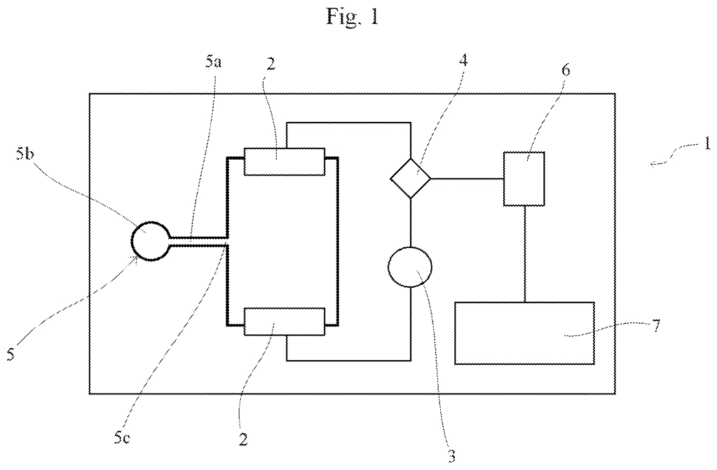

FIG. 1 shows a schematic representation of the system according to the invention. In the accompanying drawings, reference numeral 1 generically denotes a device for analysing a biological fluid, to which reference will hereinafter be made below simply as the device 1.

The term “analysing” means any process and operation aimed at obtaining information representing and indicating the presence/concentring of one or more markers inside the biological fluid.

A marker is any element, for example a molecule, present inside the biological fluid and the detection of which can be used to determine the presence of a pathology.

By way of example, cytokines, chemokine, hypercoagulation biomarkers such as D-Dimer or Reactive Protein C are considered as markers.

The term “biological fluid” is used to mean any biological fluid drawn/which can be from by an individual such as, in particular, blood or blood serum.

Structurally, the device 1 comprises at least one pair of electrodes 2, a source of electricity 3, a sensor 4, a micro-fluid circuit 5 and a transmission module 6.

The at least one pair of electrodes 2 is associated with the source of electricity 3 to define an electrochemical cell.

More in detail, the pair of electrodes 2 comprises a functionalized coating for receiving and retaining at least one marker of the biological fluid.

The coating may be applied to a single electrode of the pair or to both.

The functionalization of the coating is obtained by at least one antibody of the marker to be detected or by means of an anti-marker or with any other substance or combination of substances configured to bond with the marker of interest.

In use, the coating therefore has a composition configured to interact with the marker present in the biological fluid, retaining it.

According to an aspect of the invention, the pair of electrodes 2 is reversibly coupled to the device 1.

More specifically, the device 1 has at least one housing configured to receive the pair of electrodes 2 in such a way as to form the electrochemical cell.

The pair of electrodes can therefore be replaced in such a way that a user can introduce in the housings a pair of electrodes comprising a functionalized coating for retaining a specific marker.

Advantageously, the at least one pair of electrodes 2 may comprise a plurality of pairs of electrodes, supplied for example in a kit, wherein each pair comprises a functionalized coating for retaining a specific marker.

For this reason, the user can select as a function of the marker to be measured the pair of electrodes 2 specifically set up for retaining that specific marker and insert them into the housing of the device in order to adapt it to analyse the biological fluid for measuring that specific marker.

Operatively, the adhesion of the marker to the coating reduces the exposed surface of the electrode to which the coating is applied, consequently also reducing the electrochemically active surface area (ECSA) and therefore the intensity of the current which can be generated by the electrochemical cell as a whole.

Consequently, when the source of electricity 3 is activated, the quantity of current flowing in the electrochemical cell will be inversely proportional to the quantity of marker received and retained by the coating and therefore the amplitude of the current signal measured by the sensor 4 will be inversely proportional to the quantity of marker present in the biological fluid.

In other words, the measurement of the current flowing in the electrochemical cell makes it possible to determine the concentration of markers present in the biological fluid, since this concentration directly affects the percentage of electrically active surface of the pair of electrodes and therefore the amplitude of the signal representing the current flowing in the cell.

This measurement is performed by the sensor 4, which is configured to measure a current signal (with particular reference to an amplitude of that signal) in the electrochemical cell.

More specifically, the flow of electric current inside the electrochemical cell is obtained by activating the source of electricity in such a way as to apply a variable potential between the two electrodes of the pair of electrodes 2.

In this context, the current signal measured by the sensor is a voltammogram.

In other words, the electrochemical cell and the sensor 4 are configured for performing a measurement of voltammetry.

In more detail, the source of electricity is configured for applying to the at least one pair of electrodes 2 a potential increasing with a square wave in such a way as to perform by means of the sensor 4 a measurement of square-wave voltammetry.

In other words, the source of electricity 3 applies between the two electrodes of the pair a variable gradual potential the increase of which coincides with the start of the pulse of a square wave superposed on the gradual variation signal.

The current signal is then measured by the sensor 4, measuring the difference between the intensity of current measured in the positive and negative half-cycles of the square waves.

In this way, a peak-shaped voltammogram is obtained, the height of which is proportional to the electrically active surface of the electrode (a smaller active surface is equivalent to less electrical conductivity and therefore to a smaller quantity of current flowing through the electrochemical cell), which is in turn inversely proportional to the quantity of marker present in the biological fluid to be analysed, since the greater the concentration of the marker the greater will be the number of coating sites which can bond to the marker so as to progressively screen the surface of the electrode to which the coating is applied.

The activation of the source of electricity 3, therefore of the procedure for analysing the biological fluid for determining the concentration of at least one marker of interest, may be performed using an input device included in the device 1.

The input device may be, for example, a pushbutton which, when pressed by a user, activates the source of electricity 3 for powering the electrochemical cell and starting the measurement of the current signal associated with it.

The transfer of the biological fluid to the coating, in such a way as to allow it to interact with the latter, is mediated by the micro-fluid circuit 5, which comprises one or more conduits 5a along which the biological fluid flows.

More specifically, the micro-fluid circuit 5 has an inlet portion 5b in which a user can insert the biological fluid and an outlet portion 5c facing a chamber in which the pair of electrodes 2 is positioned.

In other words, the micro-fluid circuit 5 receives the biological fluid from the inlet portion 5b and conveys it along at least one conduit 5a, bringing it to the electrochemical cell where it can be analysed by performing the procedure indicated above.

Advantageously, the micro-fluid circuit 5 may comprise one or more tanks in fluid communication with the electrochemical cell and preferably positioned along the at least one conduit 5a along which the biological fluid is conveyed.

Inside the tank it is possible to store one or more chemical compounds necessary/useful to optimise the generation and the subsequent measurement of the current signal inside the electrochemical cell.

For example, the tank may contain a reactive agent configured to interact with the biological fluid.

The reactive agent may be, for example, aimed at the removal, decomposition, elimination of a component of the biological fluid which could influence the measurement of the current signal.

The reactive agent might also be a chemical compound such as a catalyst capable of promoting the interaction and the retaining of the marker with the coating in such a way as to make the results which can be obtained by the current signal measurement more accurate and reliable.

Further or alternatively, the tank may contain a fluidifier such as to facilitate the flowing of the biological fluid inside the conduit 5a.

Further or alternatively, the tank may contain a washing solution to be dispensed on the electrodes immediately before conveying the biological fluid in such a way as to guarantee their correct and optimum operation.

Further or alternatively, the tank may contain any substance necessary for performing the measuring process, such as, for example, one or more electrochemical solutions.

More specifically, the electrochemical solution may be a solution comprising an oxidising agent such as potassium ferricyanide, the oxidation reduction reaction of which at the interface with the pair of electrodes 2 triggered by the activation of the source of electricity 3 determines the generation of the current signal which is measured by the sensor 4.

All the substances listed above may be contained in the same tank or be contained in separate tanks each independently connected to the conduit 5a and, therefore, to the electrochemical cell.

Moreover, according to an aspect of the invention, the input device is operatively connected with each tank for selectively activating the dispensing of the substance contained inside the conduit 5a and the electrochemical cell.

In other words, by means of the input device it is possible to activate the dispensing of the substances contained in the individual tanks to the electrochemical cell and/or to the biological fluid flowing in the conduit 5a.

Advantageously, the micro-fluid circuit 5 is further configured for retaining the biological fluid (and also any substance contained in the respective containers) at the electrochemical cell, thus preventing the escape from the device 1 once it has been introduced inside it.

This prevents the accidental escape of both the biological fluid and any chemical substance contained in the device 1, allowing its use and disposal under conditions of total safety.

For this purpose, the micro-fluid circuit 5 may comprise non-return valves applied along the micro-fluid circuit.

The device 1 further comprises a transmission module configured to transmit the current signal which has been measured by the sensor 4.

Moreover, in accordance with an aspect of the invention, the device 1 comprises a graphical interface 7 (for example a display unit) and the transmission module 6 is configured for transmitting the current signal to the graphical interface 7.

the graphical interface 7 receives the current signal and is configured to display a graphical representation which can be immediately interpreted by the user.

The graphical interface 7 may be further configured for processing the current signal in such a way as to determine (and then display) one or more numerical parameters of interest concerning the marker of the biological fluid.

For example, the graphical interface 7 may process the current signal to determine a numerical value corresponding to the percentage concentration of the marker in the biological fluid.

According to another aspect of the invention, the transmission module 6 is configured for transmitting the current signal measured by the sensor 4 to a portable terminal, such as, for example, a smartphone.

Preferably, the transmission is performed using a wireless communication protocol, such as, for example, a Wi-Fi® protocol, Bluetooth® or the mobile phone network.

In this context, any steps of analysing and interpreting the current signal can be performed by the portable terminal and their result displayed on a display unit of the portable terminal.

Additionally, the transmission module may be configured to send the current signal both to the graphical interface 7 and to the portable terminal, the latter being both configured to display the same or different information and any numerical parameters associated with the current signal.

For example, the graphical interface could display only the voltammogram measured by the sensor 4 (to allow the user to immediately identify any errors in the measuring process), whilst the portable terminal could be designed to process the current signal to determine and display to the user the actual concentration of the marker in the biological fluid or other data of interest connected to it.

Advantageously, the device 1 may comprise a plurality of pairs of electrodes 2 each of which has a different functionalized coating designed to receive and retain at least one respective marker.

In this context, the device 1 comprises a plurality of pairs of housings each designed to receive a respective pair of electrodes 2.

Each of the pairs of electrodes 2 is connected to the source of electricity in such a way as to define respective autonomous electrochemical cells each of which may be selectively, individually and independently powered by the source of electricity 3.

At the same time, the micro-fluid circuit 5 is also placed in communication with each electrochemical cell by means of respective independent conduits 5a.

More specifically, the micro-fluid circuit 5 is configured for separating the biological fluid into a plurality of portions and conveying each portion to a respective pair of electrodes 2 and to a respective electrochemical cell.

In this context, the micro-fluid circuit may for example comprise a single inlet portion 5b from which extend a plurality of conduits 5a each ending in a respective outlet portion 5c facing a respective electrochemical cell.

Similarly, the micro-fluid circuit 5 also comprises different tanks which are independent and separate for each conduit 5a and/or tanks in common in fluid communication with one or more conduits 5a and/or with one or more electrochemical cells.

Again in this context, the input device may be configured to activate the measurement process (that is, activate the source of electricity 3 and the measurement of the current signal by means of the sensor 4) in each electrochemical cell simultaneously or selectively and independently in each single electrochemical cell.

Advantageously, the invention achieves the preset aims overcoming the drawbacks of the prior art by providing the user with a device for analysing a biological fluid which is structurally simple and able to receive and analyse the biological fluid generating a signal which can be rapidly interpreted to determine the concentration of a predetermined marker in the biological fluid.

1. A device for analysing a biological fluid comprising:
at least one pair of electrodes comprising a functionalized coating for receiving and retaining at least one marker of said biological fluid;
a source of electricity connected with the at least one pair of electrodes in such a way as to form with said pair of electrodes an electrochemical cell;
a sensor configured to measure a current signal in said electrochemical cell, an amplitude of said current signal being inversely proportional to a quantity of markers retained by the coating;
a micro-fluid circuit configured for conveying the biological fluid on said coating;
a transmission module configured for transmitting said current signal.

2. The device according to claim 1, wherein the coating comprises at least one anti-body of said marker or an anti-marker designed to bond with the marker of the biological fluid.

3. The device according to claim 1, comprising a graphical interface configured to receive the current signal from the transmission module and to display at least one graphical representation of the current signal.

4. The device according to claim 1, wherein the transmission module is configured to transmit, preferably by means of a wireless communication protocol, the current signal detected by the sensor to a portable terminal designed to display at least one graphical representation of the current signal.

5. The device according to claim 1, wherein the micro-fluid circuit comprises at least one tank in fluid communication with the electrochemical cell, said tank preferably being configured to contain at least one between: a reactive agent configured to bond to the marker, a fluidifier, a washing solution.

6. The device according to claim 1, wherein the micro-fluid circuit is configured to retain the biological fluid at the electrochemical cell, preventing the escape from the device.

7. The device according to claim 1, comprising an input element configured to activate the source of electricity and the sensor in such a way as to measure the current signal.

8. The device according to claim 1, wherein the source of electricity is configured for applying to the at least one pair of electrodes a variable potential and the current signal measured by the sensor comprises a voltammogram.

9. The device according to claim 8, wherein the source of electricity is configured for applying to the at least one pair of electrodes a potential increasing in the form of a square wave.

10. The device according to claim 1, comprising at least one housing designed to receive the at least one pair of electrodes in such a way as to define the electrochemical cell.

11. The device according to claim 1, comprising a plurality of pairs of electrodes, each pair having a different functionalized coating designed to receive and retain at least one respective marker and wherein the micro-fluid circuit is configured for separating the biological fluid into a plurality of portions and conveying each portion on the coating of a respective pair of electrodes.
